(19) United States
(12) Patent Application Publication
(10) Pub. No.: US 2005/0156835 A1
(43) Pub. Date: Jul. 21, 2005

(54) Driving device and method for light emitting display panel

(75) Inventor: Yousuke Sato, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/036,331

(22) Filed: Jan. 18, 2005

(30) Foreign Application Priority Data
Jan. 19, 2004 (JP) 2004-10003

(51) Int. Cl. G09G 3/30

(52) U.S. Cl. 345/76

(57) ABSTRACT

A driving device for a light emitting display panel is provided, and, according to the driving device, the optimal value of a reverse bias voltage which is used in order to prevent crosstalk light emitting during a lighting scanning period of EL elements, and the optimal value of the reverse bias voltage which is applied to the EL elements during a scanning period for not-lighting can be obtained by a simple circuit structure. Driving switches Sa1 through Sam in a data driver 2 corresponding to scanning with scanning switches Skl through Skn in a scanning driver 3 selects a charging and discharging circuit including a capacitor C for connection, and the circuit is charged. In the lighting scanning period of organic EL elements E11 through Em, a difference voltage (Vf−Vm) between a forward voltage Vf of the EL element and a reverse bias voltage Vm from a reverse bias voltage source VM is applied to the EL elements not to be scanned to prevent the crosstalk light emitting. Moreover, in the scanning period for not-lighting, a difference voltage (Vm−VL) between the reverse bias voltage Vm and a voltage VL at which the charging and discharging circuit is charged is applied to each of the EL elements as a reverse bias voltage. The latter difference voltage can be obtained as a voltage level which is optimal for longer light-emitting life of the EL elements and self repairing of leak phenomena of the EL elements.

### BACKGROUND OF THE INVENTION

1. Field of the Invention

The present invention relates to a driving device for a passive matrix type light emitting display panel, using, for example, an organic electrolight emitting (EL) element as a self light emitting element, especially, to a driving device and a driving method for a light emitting display panel which can apply a reverse bias voltage to the self light emitting element.

2. Description of the Related Art

Development of a display panel using a display panel with a configuration in which the light emitting elements are arranged like a matrix has been widely promoted, and for example, an organic EL element which uses an organic material for the light emitting layer has received widespread attention as a light emitting element used for such a display panel. The background for such attention is that the organic EL has had higher efficiency and longer life by using an organic compound, which is expected to have preferable characteristics fit for practical use, for a light emitting layer of the EL element.

A light emitting element with diode characteristics and a parasitic capacitance component connected to the light emitting element in parallel can be electrically used for the organic EL element, and it may be said that the organic EL element is a capacitive light emitting element. When a light emitting driving voltage is applied to the organic EL element, electrical charge corresponding to the electric capacity of the element flows into an electrode as a displacement current for accumulating in the first place. Subsequently, when a predetermined voltage (light emitting threshold voltage=Vth) inherent to the element is exceeded, a current starts to flow into an organic layer forming the light emitting layer from the other electrode (the anode side of the diode component), and light is emitted with intensity proportional to the current according to an idea.

On the other hand, as the organic EL element has current and the intensity characteristics steady to temperature changes and voltage and intensity characteristics highly dependent on the temperature changes, and suffers severe deterioration when an overcurrent is received to reduce light emission life, the organic EL element is generally driven at a constant current. In some quarters, a passive-driving-type display panel in which the elements are arranged like a matrix has already been put into practical use as a display panel using such an organic EL element.

FIG. 1 shows one example of a circuit for a conventional passive matrix type display panel, and that of a driving circuit for the panel. There are a cathode-line scanning and anode-line driving method and an anode-line scanning and cathode-line driving method for a method by which an organic EL element is driven in the passive matrix driving method. A configuration shown in FIG. 1 shows a form of the cathode-line scanning and anode-line driving. That is, m pieces of data lines (hereafter, also called anode lines) A1 through Am are arranged in the vertical direction, and n pieces of scanning lines (hereafter, also called cathode lines) K1 through Kn are arranged in the horizontal direction. Organic EL elements E11 through Emn represented by symbolic marks of a diode and a capacitor which are connected to each other in parallel are arranged at intersecting portions of the data lines and the scanning lines (m×n positions in total) to form a display panel 1.

Then, one end (the anode terminal of an equivalent diode to the EL element) is connected to an anode line, and the other one (the cathode terminal of the equivalent diode to the EL element) is connected to a cathode line in each EL element E11 through Emn forming a pixel, corresponding to intersecting points between the anode lines A1 through Am along in the vertical direction and the cathode lines K1 through Kn in the horizontal direction. Moreover, the anode lines A1 through Am are connected to an anode line driving circuit 2, and the cathode lines K1 through Kn are connected to a cathode line scanning circuit 3 for each driving.

The anode-line driving circuit 2 comprises constant current sources I1 through Im, which operate, using a driving voltage Vh from-a driving voltage source VH, and driving switches Sa1 through Sam are provided, and operates in such a way that, by connecting the driving switches Sa1 through Sam to the sides of the constant current sources I1 through Im, currents from the constant current sources I1 through Im are supplied to each EL element E11 through Emn, which is arranged corresponding to the cathode lines, as a driving current. Moreover, the driving switches Sa1 through Sam have a configuration in which a reverse bias voltage Vm from a reverse bias voltage source VM, a pre-charging voltage Vr from a pre-charging voltage source VR, or, ground potential GND as a reference potential point are supplied to individual EL elements E11 through Emn arranged corresponding to the cathode lines.

On the other hand, the cathode-line scanning circuit 3 comprises scanning switches Sk1 through Skn corresponding to the cathode lines K1 through Kn, and the switches Sk1 through Skn operate to realize connection in such a way that either of the reverse bias voltage Vm, by which crosstalk light-emitting and the like are prevented, from the reverse bias voltage source VM, or the ground potential GND as the reference potential point is applied to the corresponding cathode lines.

Control signals are supplied from a light emitting control circuit including a not shown CPU to the anode line driving circuit 2 and the cathode line scanning circuit 3 through a control bus, and the scanning switches Sk1 through Skn and the driving switches Sa1 through Sam are switched according to image signals to be displayed. Thereby, as the constant current sources I1 through In are connected to a desired anode line for selective light emitting of the EL elements E11 through Emn while the cathode line scanning is performed and the cathode lines are set at the ground potential with a predetermined cycle according to the image signals, an image according to the image signal is displayed on the display panel 1.

Here, in the state shown in FIG. 1, a second cathode line K2 is set at the ground potential and is made in a scanning state. At this time, the reverse bias voltage Vm from the reverse bias voltage source VM is applied to the cathode lines K1, K3 through Km, which are not in the scanning state. Here, potential setting is done in such a way that the following relation is obtained under assumption that a forward voltage of an EL element in the scanning and light emitting state is Vf:
[(FORWARD VOLTAGE Vf)−(REVERSE-BIAS VOLTAGE Vm)]<(LIGHT EMITTING THRESHOLD VOLTAGE VTH)
Accordingly, the EL elements, which are connected to intersecting points of anode lines under driving and cathode lines which are not selected for scanning, operate in such a way that crosstalk light-emitting is prevented.

Incidentally, when, for example, a case in which tens of EL elements are connected to one anode line is made as an example, combined capacitance which is equal to or larger than hundreds of times each parasitic capacitance is connected to the anode line as load capacitance from the view of the anode line, because the organic EL elements arranged on the display panel 1 have individually parasitic capacitance as described above, and are arranged like a matrix at intersecting positions of the anode lines and the cathode lines. This combined capacitance is remarkably increased as the matrix size becomes larger.

Accordingly, time delay is caused before the above-described load capacitance is charged in such a way that the light emitting threshold voltage Vth of the EL element is sufficiently exceeded at the initial point of the lighting scanning period of the EL element because currents from the above-described constant current sources I1 through Im via an anode line are used in order to charge the above-described combined load capacitance. Accordingly, there has been generated a problem that starting up of light emitting for the EL elements is delayed (slowly started). Especially, when the constant current sources I1 through Im are used as the driving source of the EL elements, the currents are limited to cause remarkable delay in starting up of light emitting for the EL elements because the constant current sources are an output circuit with high impedance from a view point of an operation principle.

That is, the lighting hour rate of the EL elements is reduced. Accordingly, there has been brought about a problem that the substantial light-emitting intensity of the EL elements is reduced. Then, the pre-charging voltage source VR is provided in the configuration shown in FIG. 1 in order to eliminate the delay in starting up of light emitting for the EL elements, wherein the delay is caused by the parasitic capacitance.

FIG. 2 is a timing chart showing driving operation for lighting of an EL element, and the chart includes a pre-charging period during which the parasitic capacitance of the EL element is charged by using the pre-charging voltage source VR. Moreover, FIG. 3 shows operation timing including a scanning period for not-lighting which is provided in order to securely apply a reverse bias voltage to the EL element in one frame period. Moreover, FIG. 4 is a table showing relations among voltages applied to data lines, and scanning lines in each period.

FIG. 2(a) shows a synchronizing signal for scanning, and, in the first place, a resetting period is set in synchronization with the synchronizing signal for scanning as shown in FIG. 2(b) in this example. This resetting period is set in order to discharge charges accumulated in each EL element, which is arranged on the display panel 1, as parasitic capacitance. In this period, the reverse bias voltage Vm or the ground potential GND from the reverse bias voltage source VM is supplied to all the data lines and the scanning lines as shown in FIG. 4.

That is, the driving switches Sa1 through Sam are connected to the side of the reverse bias voltage source VM in FIG. 1 to apply the reverse bias voltage Vm to respective data lines A1 through Am. At this time, the scanning switches Sk1 through Skn are also connected to the side of the reverse bias voltage VM to apply the reverse bias voltage Vm to respective scanning lines K1 through Kn. Accordingly, charges accumulated in the parasitic capacitance of each EL element on the display panel 1 are discharged to cause a resetting state. Here, the configuration shown in FIG. 1 makes it possible to realize the resetting state even by connecting the driving switches Sa1 through Sam, and the scanning switches Sk1 through Skn to the ground potential GND.

At a pre-charging period shown in FIG. 2(c) after the lapse of the resetting period, the parasitic capacitance of the EL elements to be scanned are charged at a voltage approximately equal to the light emitting threshold voltage Vth. In this pre-charging period, the pre-charging voltage Vr is applied to the data lines, and the ground potential GND is applied to the selection scanning lines to be scanned as shown in FIG. 4. Moreover, the reverse bias voltage Vm is applied to non-selection scanning lines.

That is, in FIG. 1, the driving switches Sa1 through Sam select the side of the pre-charging voltage source VR, the scanning switch Sk2 corresponding to a selection scanning line, for example, to a second scanning line K2 selects the ground potential, and other scanning switches Sk1, Sk3 through Skn select the side of the reverse bias voltage source VM. Thereby, the pre-charging voltage Vr from the pre-charging voltage source VR is applied to the parasitic capacitance of each EL element which is connected to the second scanning line K2 of the selection scanning line, and the voltage Vr is charged to the parasitic capacitance of the EL element which is connected to the second scanning line K2.

Then, at the scanning period for lighting as the subsequent step as shown in FIG. 2(d), currents from the constant current sources I1 through Im are supplied to the EL elements to be lighted as shown in FIG. 4. Moreover, the scanning switch Sk2 corresponding to a selection scanning line, for example, to the second scanning line K2 selects the ground potential, and other scanning switches Sk1, Sk3 through Skn select the side of the reverse bias voltage source VM.

Thereby, among the EL elements which are connected to the second scanning line K2 as the selection line and are pre-charged, the EL elements to be lighted are driven for light emitting at once. As a result, the forward voltage Vf of the EL elements are generated at the data lines. At this time, the reverse bias voltage Vm is applied to non-selection scanning lines, and, as described above, the EL elements which are connected to intersecting points of data lines under driving and scanning lines which are not selected for scanning, operate in such a way that crosstalk light-emitting is prevented. And, operations during the resetting period, the pre-charging period, and, the scanning period for lighting are repeated one by one in synchronization with the synchronizing signal for scanning, which is shown in FIG. 2(a).

Incidentally, it has been known (for example, refer to Japanese Patent Publication NO. 2002-169510 (Paragraph Number 0012 and FIG. 2)) that the light-emitting life of the organic EL elements can be extended by applying the reverse direction voltage (reverse bias voltage), which does not contribute to light-emitting operation, one by one to the EL elements. Moreover, it has been also known (for example, refer to Japanese Patent Publication NO. 2001-117534 (Paragraph Numbers 0023 through 0025 and FIG. 8)) that self-repairing of the leakage phenomenon of the organic EL elements can be realized by applying the reverse bias voltage to the EL elements.

On the other hand, the passive-driving-type display panel has a configuration, as explained above, in which the reverse bias voltage Vm is applied to non-selection scanning lines to prevent crosstalk light-emitting, and, generally, the reverse bias voltage Vm has a value smaller than that of the forward voltage Vf of the EL element. Accordingly, when some of, or all the EL elements forming the display panel keeps the lighting state for several frames or tens of frames, there is generated no opportunities to apply the complete reverse bias voltage to the terminals of the EL elements, and the advantages disclosed in Japanese Patent Publication NO. 2002-169510 and Japanese Patent Publication NO. 2001-117534 cannot be obtained.

Then, the configuration shown in FIG. 1 is considered to adopt a means by which the scanning period for not-lighting is set, for example, at the end of one frame period as shown in FIGS. 3 and 4. This scanning period for not lighting causes an opportunity to apply the reverse bias voltage to all the EL elements by a configuration in which, after usual scanning by which n pieces of scanning lines are scanned is executed as shown in FIG. 3, approximately several virtual scanning lines are set, and the virtual scanning lines are selectively scanned.

In this scanning period for not-lighting, the data lines are set at the ground GND as shown in FIG. 4, and each scanning line is set at the reverse bias voltage Vm. That is, the driving switches Sa1 through Sam shown in FIG. 1 select the ground GND, and the scanning switches Sk1 through Skn select the reverse bias voltage source VM. Thereby, an opportunity to apply the reverse bias voltage Vm to all the EL elements is surely given to each EL element arranged on the display panel 1 for at least one frame, not depending on the lighting state of a pixel. Accordingly, by setting the scanning period for not-lighting, each EL element arranged on the display panel 1 can obtain advantages of longer light-emitting life of the elements and self repairing of leak phenomena of the elements, which have been disclosed in Japanese Patent Publication NO. 2002-169510 and Japanese Patent Publication NO. 2001-117534.

Recently, along with a larger display screen, the number n of scanning lines has been required to be increased in order to improve the resolution of an image. However, as in this kind of the passive-driving-type display panel, the lighting hour rate of the elements is reduced as the number of scanning lines is increased, a means by which reduction in the intensity is compensated by increasing the instantaneous light emitting intensity of the elements is forced to be adopted.

For example, when the existing number 64 of scanning lines is increased to the number 96, the forward voltage Vf of the elements, for example, 14 V is required to be set at approximately 18 V in order to increase the instantaneous light emitting intensity of the elements. On the other hand, the reverse bias voltage Vm is supplied to the non-selection scanning lines in order to prevent the EL elements connected to the non-selection scanning lines from emitting light against the purpose (crosstalk). Accordingly, Vm of, for example, 11 V is required to be increased to 15V as the forward voltage Vf is increased. Thereby, a difference value Vf−Vm can be configured to be approximately 4 V, that is, the value of Vf−Vm can be configured to be equal to or smaller than the light emitting threshold voltage Vth at any time.

However, when the reverse bias voltage Vm is increased, the value of the reverse bias voltage applied to the elements is also increased in the scanning period for not-lighting explained based on FIGS. 3 and 4 to cause a problem that the optimum range for the reverse bias voltage (for example, approximately 11 V), within which advantages of longer light-emitting life and self repairing ability of the elements are obtained, is exceeded. That is, the inventors of the present invention have verified that, in the scanning period for not-lighting explained based on FIGS. 3 and 4, the light emitting life of the elements is rather reduced as a result when the value of the reverse bias voltage applied to the elements is too large.

Then, there is considered a configuration in which the value of the reverse bias voltage in the scanning period for lighting, by which the crosstalk light emitting is prevented, and the value of the reverse bias voltage, which is applied in the scanning period for not-lighting in order to obtain the advantages of the longer life and the self repairing ability of the elements, are controlled in such a way that are changed to the optimum value as required according to the timing. Moreover, there can be another configuration in which a constant voltage source outputting the reverse bias voltage in the scanning period for lighting, and another constant voltage source outputting the reverse bias voltage in the scanning period for not-lighting are provided, and one of the sources are controlled to be selected. However, when such a means is adopted, there is caused a problem that the scale of the power supply circuit is increased to cause greater cost and a disadvantage in the space.

### SUMMARY OF THE INVENTION

This invention has been made, based on the above-described technical background, and the object is to provide a driving device and a driving method for a light emitting display panel, by which an optimum value of a reverse bias voltage can be obtained both in a scanning period for lighting and in a scanning period for not-lighting without hardly increase in the size of a power supply circuit as described above. Moreover, another object of this invention, other than the above-described one, is to provide driving device and a driving method for a light emitting display panel, in which the pre-charging voltage source is eliminated to simplify the configuration of the power source circuit.

A driving device according to a preferred embodiment of the present invention, which has been made in order to solve the problems, is a driving device for a light emitting display panel of a passive matrix type comprising a plurality of scanning lines and a plurality of data lines, which are intersecting one another, and self light emitting elements connected to each of the scanning lines and each of the data lines at intersecting positions of the scanning lines and data lines, wherein the device comprises switching means, by which each of the scanning lines is set at a selection scanning voltage or a non-selection scanning voltage, at the side of a scanning driver and switching means, by which each of the data lines is connected to a lighting driving power source, or a not-lighting driving power source, at the side of a data driver, and the not-lighting driving power source comprises a charging and discharging circuit.

Moreover, a driving device according to another preferred embodiment of the present invention is a driving device for a light emitting display panel of a passive matrix type comprising a plurality of scanning lines and a plurality of data lines, which are intersecting one another, and self light emitting elements connected to each of the scanning lines and each of the data lines at intersecting positions of the scanning lines and data lines, wherein the device comprises switching means, by which each of the scanning lines is set at a selection scanning voltage or a non-selection scanning voltage, at the side of a scanning driver and switching means, by which each of the data lines is connected to any one of a lighting driving power source, a not-lighting driving power source, or a pre-charging voltage source, at the side of a data driver, and the not-lighting driving power source and the pre-charging voltage source comprise at least one charging and discharging circuit.

Furthermore, a driving method according to a preferred embodiment of the present invention which has been made in order to solve the above-described problems, is a driving method for a light emitting display panel of a passive driving type which comprises a plurality of scanning lines and a plurality of data lines which are intersecting one another, and self light emitting elements connected to each of the scanning lines and each of the data lines at intersecting positions of the scanning lines and data lines, wherein the method includes the following steps to be executed: a charging step in which a charging and discharging circuit is charged by setting each of the scanning lines at a selection scanning voltage one by one, by setting other scanning lines, which have not been set at the selection scanning voltage, at a non-selection scanning voltage, and by using charges accumulated in the parasitic capacitance of the light emitting elements which is corresponding to the scanning lines set at the non-selection scanning voltage; and a step for applying a reverse bias voltage, in which a difference voltage between the non-selection scanning voltage and a voltage at which a charging and discharging circuit is charged is applied to the self light emitting elements as a reverse bias voltage by setting all the scanning lines at the non-selection scanning voltage.

Still furthermore, a driving method according to another preferred embodiment of the present invention, which has been made in order to solve the above-described problems, is a driving method for a light emitting display panel of a passive driving type which comprises a plurality of scanning lines and a plurality of data lines, which are intersecting one another, and self light emitting elements connected to each of the scanning lines and each of the data lines at intersecting positions of the scanning lines and data lines, wherein the method includes the following steps to be executed: a charging step in which a charging and discharging circuit is charged by setting each of the scanning lines at a selection scanning voltage one by one, by setting other scanning lines which have not been set at the selection scanning voltage at a non-selection scanning voltage, and by using charges accumulated in the parasitic capacitance of the light emitting elements which is corresponding to the scanning lines set at the non-selection scanning voltage; a step for applying a reverse bias voltage, in which a difference voltage between the non-selection scanning voltage and a voltage at which a charging and discharging circuit is charged is applied to the self light emitting elements as a reverse bias voltage by setting all the scanning lines at the non-selection scanning voltage; and a pre-charging step in which the parasitic capacitance of the self light emitting elements is charged at a forward voltage less than a light emitting threshold voltage by using a voltage at which the charging and discharging circuit is charged.

### BRIEF DESCRIPTION OF THE DRAWINGS

FIG. 1 is a connection diagram showing examples of a passive matrix type display panel and a driving circuit therefor;

FIG. 2 is a timing chart showing a driving operation for lighting in the display panel shown in FIG. 1;

FIG. 3 is a timing chart showing one example in which a scanning period for not-lighting is provided in one frame period;

FIG. 4 is a drawing showing relations among voltages which are applied to data lines and scanning lines in each period;

FIG. 5 is a connection diagram showing a driving device according to a first embodiment of the present invention;

FIG. 6 is a timing chart showing one example in which a scanning period for not-lighting is provided in one frame period with regard to the configuration shown in FIG. 5;

FIG. 7 is a drawing showing relations among voltages which are applied to data lines and scanning lines in each period with regard to the configuration shown in FIG. 5;

FIG. 8 is a connection diagram explaining operations in a charging period with regard to the configuration shown in FIG. 5;

FIG. 9 is a connection diagram showing a driving device according to a second embodiment of the present invention;

FIG. 10 is a drawing showing relations among voltages which are applied to data lines and scanning lines in each period with regard to the configuration shown in FIG. 9; and

FIG. 11 is a connection diagram explaining operations in a charging period with regard to the configuration shown in FIG. 9.

### DESCRIPTION OF THE PREFERRED EMBODIMENTS

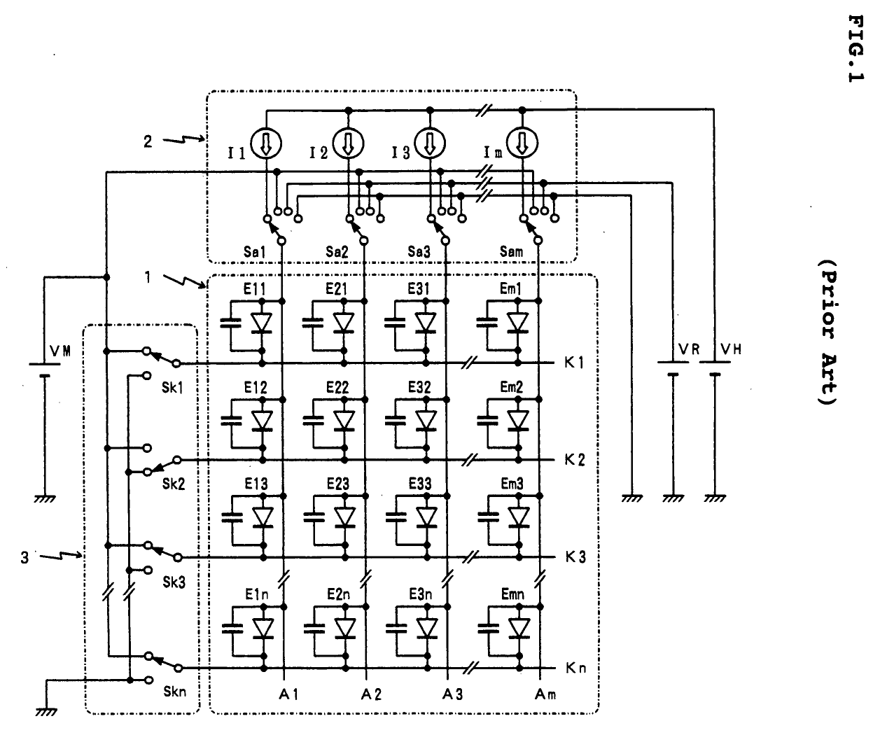

Hereinafter, a driving device for a light emitting display panel according to this invention will be explained based on an embodiment shown in drawings. FIG. 5 shows a first embodiment. The difference between a configuration shown in FIG. 5 and that of shown in FIG. 1, which has been already explained, is a configuration in which driving switches Sa1 through Sam is selectively connected not to a ground potential GND, but to a charging and discharging circuit comprising a capacitor C and a Zener diode ZD. Here, in FIG. 5 components similar to those in the configuration in FIG. 1 are denoted by the same reference numerals as those in FIG. 1, and detailed description will be eliminated.

In the charging and discharging circuit (also called a not-lighting driving power supply source), the capacitor C and the Zener diode ZD are connected in parallel. Accordingly, the maximum charging voltage in this charging and discharging circuit is defined by the Zener voltage (as one example, 4V as described later) of the Zener diode ZD. Then, relations among other voltages in the configuration shown in FIG. 5 will be explained under a condition that the forward voltage Vf of EL elements is set at 18 V as one example, and a reverse bias voltage Vm from a reverse bias voltage source VM is set at 15 V as one example by increasing the number of scanning lines as explained above.

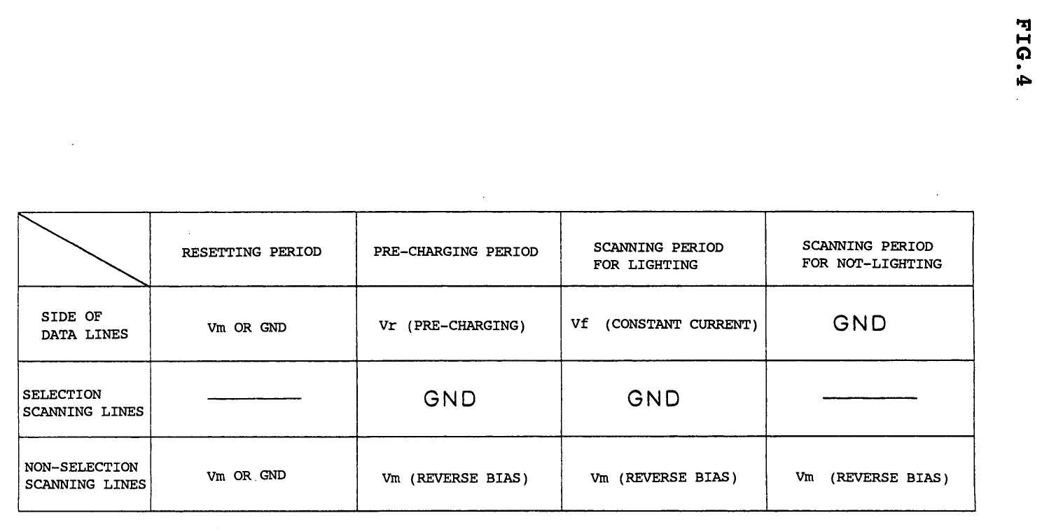

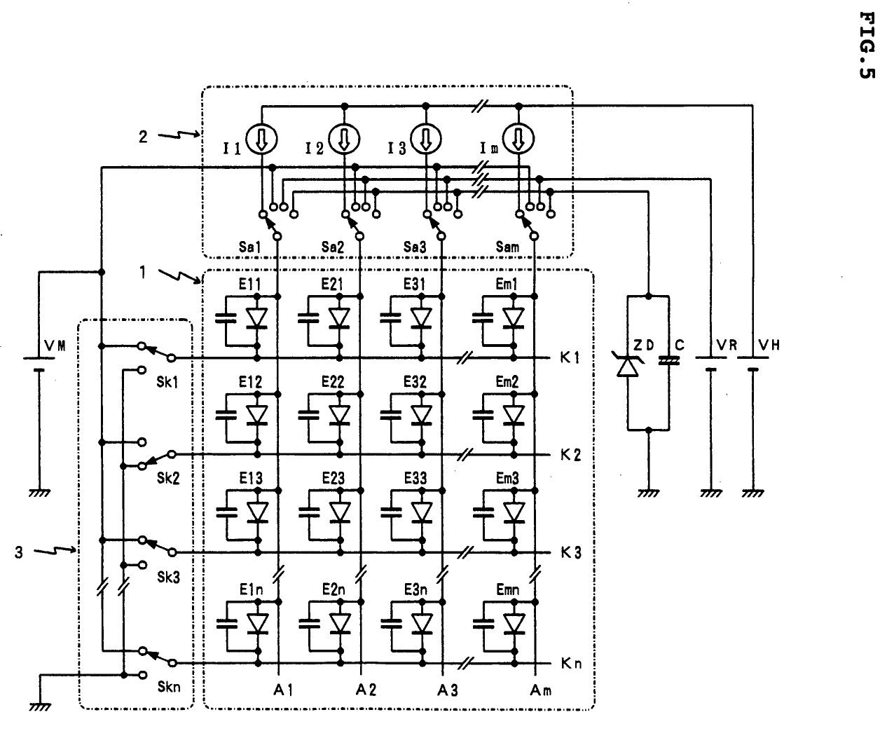

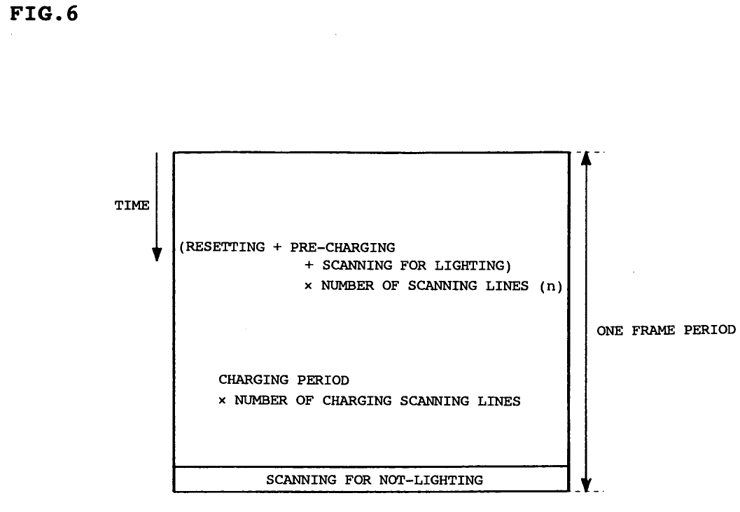

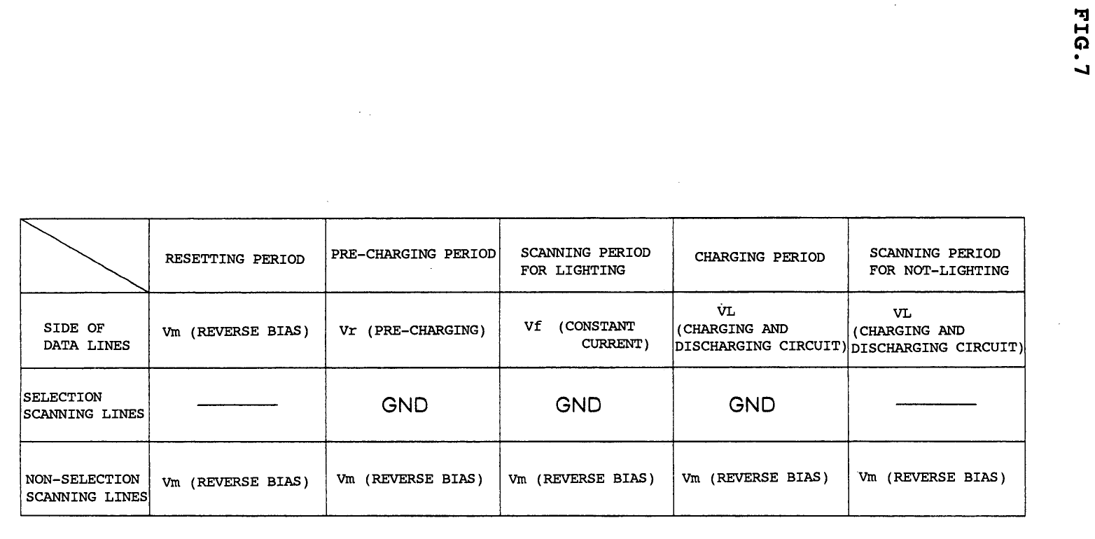

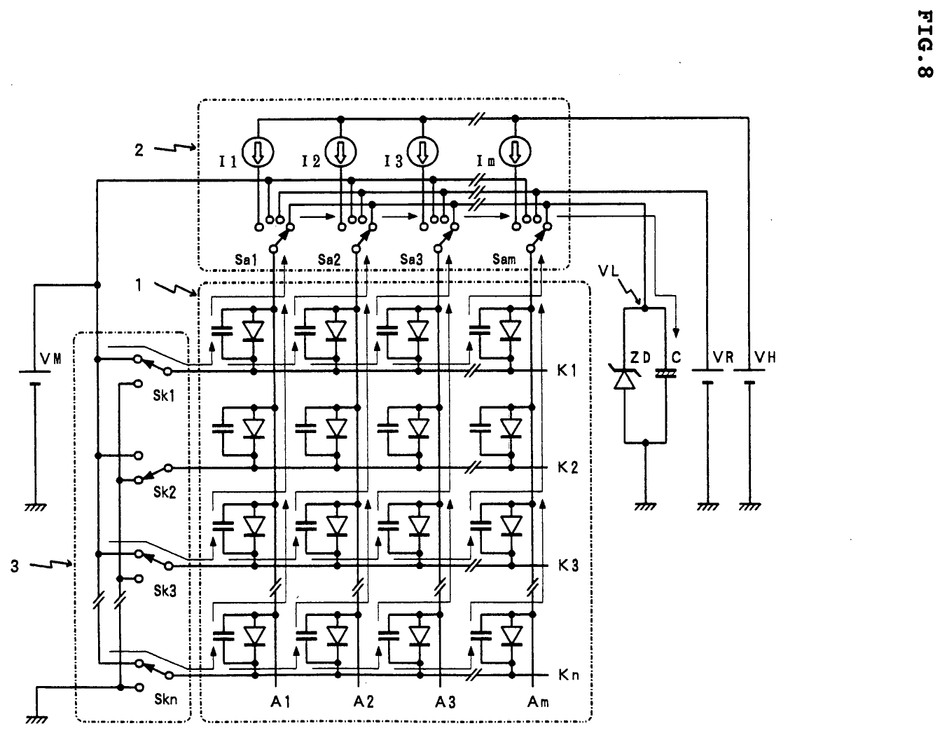

FIG. 6 shows operation timing including a scanning period for not-lighting which is provided in order to securely apply the reverse bias voltage to the EL elements in one frame period. Moreover, FIG. 7 is a table showing relations among potentials applied to data lines, and scanning lines in each period. Here, FIGS. 6 and 7 are corresponding to FIGS. 3 and 4 which have already been explained.

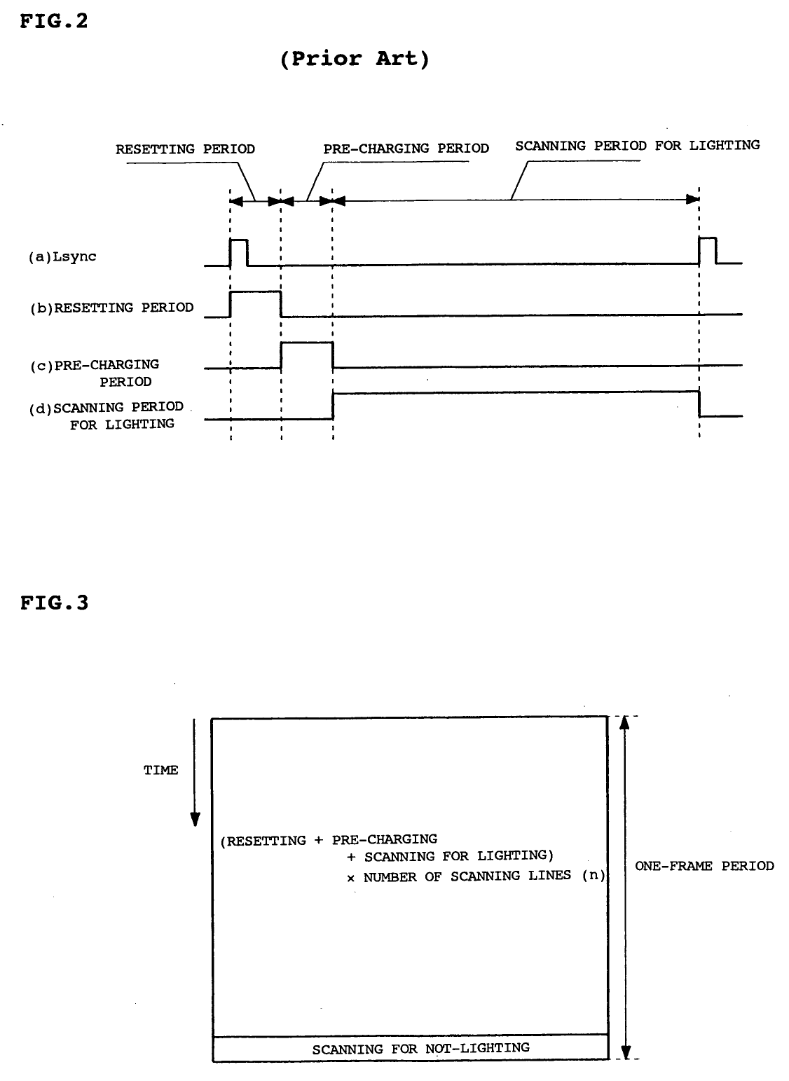

As shown in FIG. 2(b), a resetting period is set in the first place in synchronization with the synchronizing signal for scanning, which is shown in FIG. 2(a), even in the embodiment shown in FIG. 5. This resetting period is set in order to discharge charges accumulated in each EL element, which is arranged on the display panel 1, as parasitic capacitance as already explained. In this period, the reverse bias voltage Vm from the reverse bias voltage source VM is supplied to all the data lines and the scanning lines as shown in FIG. 7.

That is, the driving switches Sa1 through Sam in FIG. 5 (described as switching means for the side of a data driver in the claims) are connected to the side of a reverse bias voltage source VM to apply the reverse bias voltage Vm to data lines A1 through Am. At this time, scanning switches Sk1 through Skn (described as switching means for the side of a scanning driver in the claims) are also connected to the side of the reverse bias voltage source VM to apply the reverse bias voltage Vm to scanning lines K1 through Kn. Accordingly, charges accumulated in the parasitic capacitance of each EL element on the display panel 1 are discharged to cause a reset state.

At a pre-charging period shown in FIG. 2(c) after the lapse of the resetting period, the parasitic capacitance of the EL elements with to be scanned are charged at a voltage, which is approximately equal to, but less than a light emitting threshold voltage (Vth). In this pre-charging period, the pre-charging voltage Vr is applied to the data lines, and the ground potential GND as a selection scanning voltage is applied to selection scanning lines to be scanned as shown in FIG. 7. Moreover, the reverse bias voltage Vm as a selection scanning voltage is applied to non-selection scanning lines.

That is, in FIG. 5, the driving switches Sa1 through Sam select the side of a pre-charging voltage source VR, the scanning switch Sk2 corresponding to a selection scanning line, for example, a second scanning line K2 selects the side of the ground potential, and other scanning switches Sk1 and Sk3 through Skn select the side of the reverse bias voltage source VM. Thereby, the pre-charging voltage Vr from the pre-charging voltage source VR is applied in the forward direction is applied to the parasitic capacity of the EL elements connected to the second scanning lines K2 of the selection scanning line, and the parasitic capacity of the EL elements, which are connected to the second scanning lines K2, are charged at the voltage Vr.

At the subsequent period of the scanning period for lighting, which is shown in FIG. 2(d), currents from constant current sources I1 through Im as lighting driving power sources are supplied to the EL elements to be lighted as shown in FIG. 7. Moreover, the scanning switch Sk2 corresponding to a selection scanning line, for example, to the second scanning line K2 selects the ground potential, and other scanning switches Sk1, Sk3 through Skn select the side of the reverse bias voltage source VM.

Thereby, among the EL elements which are connected to the second scanning line K2 of the selection line and are pre-charged, the EL elements to be lighted are driven for light emitting at once. As a result, the forward voltage Vf (=18 V) of the EL elements is generated to the data line. At this time, the reverse bias voltage Vm (=15 V) is applied to non-selection scanning lines, a voltage (Vf−Vm=3V) less than a light emitting threshold voltage (Vth) is applied to the EL elements, which are connected to intersecting points of data lines under driving and scanning lines which are not selected for scanning to prevent crosstalk light-emitting of the EL elements which are not in the scanning state.

And, operations during the resetting period pre-recorded, the pre-charging period, and, the scanning period for lighting are repeated one by one in synchronization with the synchronizing signal for scanning, which is shown in FIG. 2(a). Here, in this embodiment, a charging period is set just after a series of the scanning period for lighting as shown in FIG. 6. In this charging period, the data lines are connected to a charging circuit which functions as a not-lighting driving power source, the selection scanning lines are set at the ground potential GND, and the reverse bias voltage Vm is applied to the non-selection scanning lines.

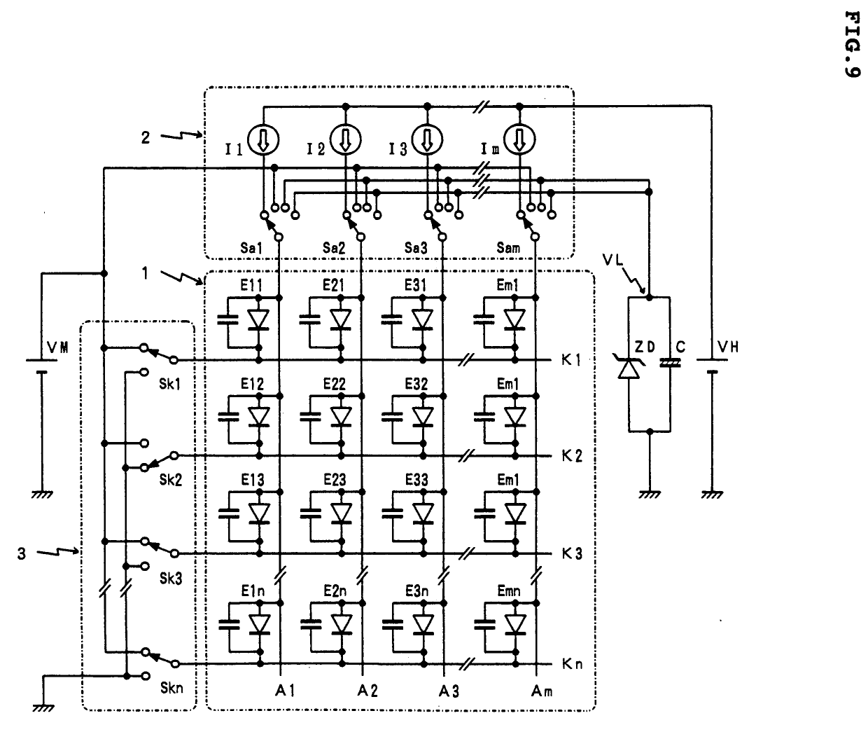

In this case, in the scanning period for lighting the driving switches Sa1 through Sam are switched to the side of the charging and discharging circuit from the side of the constant current sources I1 through Im as the lighting driving power source one by one according to gradation data of image signals. FIG. 8 shows a state in which all the driving switches Sa1 through Sam are switched to the side of the charging and discharging circuit. According to arrows showing current flows at the state, the capacitor C in the charging and discharging circuit is charged by charges, which have been accumulated in the parasitic capacitance of the EL elements that have not been selected for scanning, through the driving switches Sa1 through Sam. Here, the maximum charging voltage, at which the capacitor C is charged by the above charging operation, is limited to the Zener voltage (VL=4V) of the Zener diode ZD as described above.

When the above charging operation is configured to be executed every scanning for lighting of all the scanning lines, operation programs can be simplified. However, the charging operation is not required to be executed every scanning for lighting of all the scanning lines, the charging operation may be executed at scanning of the scanning lines in a specific period, for example, in the latter half of one frame. Furthermore, the charging operation may be executed at scanning for lighting of a part of scanning lines selected corresponding to the gradation data. That is, as, in this charging operation, scanning lines with large total intensity, which are calculated beforehand according to the gradation data are selected, and the charging operation is executed at scanning of the scanning lines, efficient charging operations can be executed for the charging and discharging circuit.

And, it is preferable that the capacitance of the capacitor C forming the charging and discharging circuit is configured to be set at a value larger than the sum of all the values of the parasitic capacitance of the EL elements arranged on the light emitting display panel 1. In this case when there can not be provided for mounting one capacitor with large capacitance it can be considered that capacitors with small capacitance are connected in parallel. Moreover, the charging and discharging circuit can have another configuration in which a combination of a capacitor C and a Zener diode ZD is prepared every data line, instead of a configuration in which one capacitor C receives charging currents from all the data lines as shown in FIG. 8.

Thus, as shown in FIG. 6, a scanning period for not-lighting is set after a series of scanning periods for lighting and charging periods, corresponding to scanning lines, for example, at the end of one frame period. This scanning period for not-lighting is similar to that which has been explained based on FIG. 3. There is given an opportunity to apply the reverse bias voltage to all the EL elements by a configuration in which, after usual scanning by which n pieces of scanning lines are scanned is executed, approximately several virtual scanning lines are set, and the virtual scanning lines are selectively scanned.

In this scanning period for not-lighting the side of the data lines are connected to the charging and discharging circuit which functions as a not-lighting driving power source as show in FIG. 7, and the reverse bias voltage Vm is applied to the scanning lines. That is, the driving switches Sa1 through Sam shown in FIG. 5 select the charging and discharging circuit, and the scanning switches Sk1 through Skn selects the reverse bias voltage source VM. Thereby, a difference voltage (=11 V) between the reverse bias voltage (Vm=15 V) as a non-selection scanning voltage and a voltage (VL=4 V) at which the charging and discharging circuit as a not-lighting driving power source is charged, is applied to the EL elements arranged on the display panel 1 as a reverse bias voltage.

The difference voltage (=11 V) is the optimal voltage, as already explained, by which the advantages of the longer light-emitting life of the EL elements and the self repairing of leak phenomena of the EL elements are obtained. Therefore, according to the first embodiment of the present invention, which has been explained referring to FIGS. 5 through 8, the value of the reverse bias voltage by which the crosstalk light emitting is prevented during the lighting scanning period of the EL elements, and the optimal voltage which is applied to the EL elements as the reverse bias voltage during the scanning period for not-lighting can be obtained by a simple circuit structure.

Subsequently, FIG. 9 explains a driving device according to a second embodiment of the present invention. In FIG. 9, components with similar functions to those of components in the configuration shown in FIG. 5 are denoted by the same reference numerals as those in FIG. 1, and detailed description will be eliminated. The second embodiment shown in this FIG. 9 has a configuration in which, in comparison with the configuration shown in FIG. 5 explained, the pre-charging voltage source VR is eliminated, and a potential (VL=4 V) at which a charging and discharging circuit which functions as a not-lighting driving power source is used as a pre-charging voltage. That is, the not-lighting driving power source and the pre-charging voltage source comprises a common charging and discharging circuit including a capacitor C.

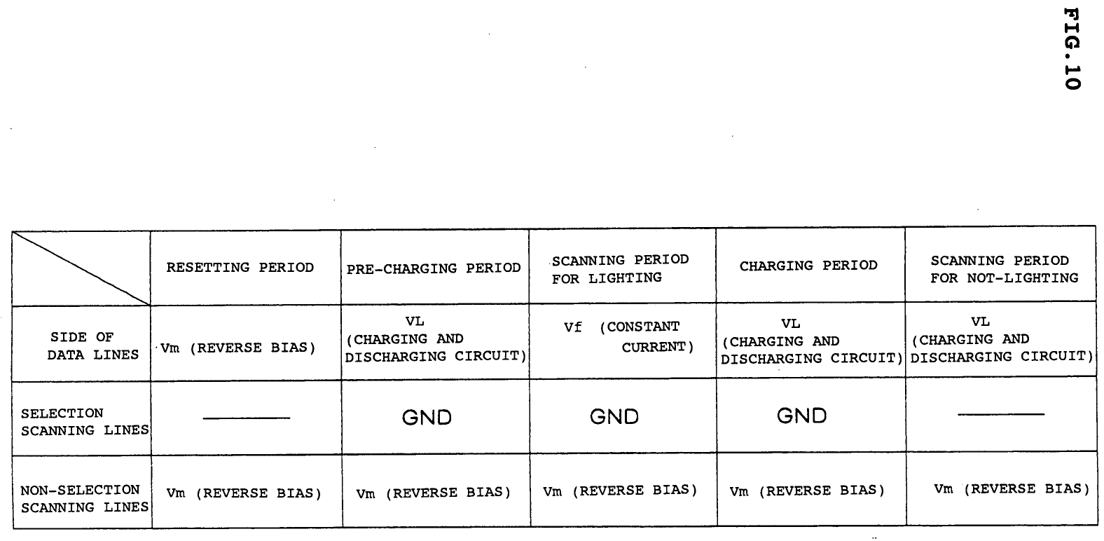

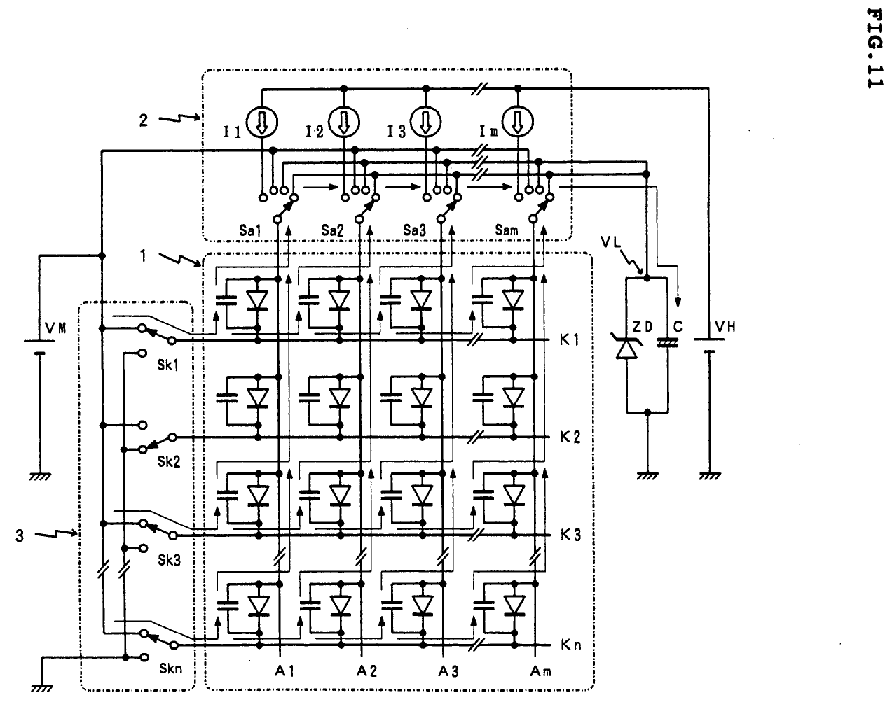

FIG. 10 is a table showing relations among voltages applied to data lines, and scanning lines in each period in the configuration shown in FIG. 9, and FIG. 10 is corresponding to FIG. 7 explained above. As the potential (VL=4 V) at which the charging and discharging circuit is charged in the pre-charging period is used as the pre-charging voltage in the configuration shown in FIG. 9 as described above, the data lines are controlled to be connected to the charging and discharging circuit in the pre-charging period shown in FIG. 10. Here, relations among potentials supplied to the data lines and scanning lines in other periods are similar to those shown in FIG. 7.

Here, in this embodiment, the pre-charging voltage depends on a Zener voltage of a Zener diode ZD in the charging and discharging circuit. Accordingly, the pre-charging voltage less than a light emitting threshold voltage Vth of the EL elements can be easily secured.

According to the second embodiment of the present invention shown in FIG. 9, the value of the reverse bias voltage by which the crosstalk light emitting is prevented during the lighting scanning period of the EL elements, and the optimal voltage which is applied to the EL elements as the reverse bias voltage during the scanning period for not-lighting can be obtained by a simple circuit structure, in a similar manner to that of the first embodiment explained above. Moreover, as a pre-charging voltage source can be eliminated according to the configuration shown in FIG. 9, a simpler configuration for a power source circuit can be realized.

Here, FIG. 11 shows a configuration in which the configuration shown in FIG. 9 is in a state during the charging period, and corresponds to FIG. 8 which has already been explained. Even in the second embodiment, driving switches Sa1 through Sam is switched from the side of constant current sources I1 through Im to the side of a charging and discharging circuit one by one according to gradation data of image signals. At this time, according to arrows showing current flows, the capacitor C in the charging and discharging circuit is charged by charges which have been accumulated in the parasitic capacitance of the EL elements that have not been selected for scanning through the driving switches Sa1 through Sam.

Like this example, it is preferable that the charging and discharging circuit is provided with a capacitor C with comparatively large capacitance when the charging and discharging circuit is used as a pre-charging voltage source. Thereby, variations in an amount of pre-charging voltages applied to EL elements to be scanned for lighting can be suppressed.

Though examples in which organic EL elements are used as a self light emitting element arranged on a display panel have been shown in the above-explained embodiments, other capacitive elements with diode characteristics can be used as the self light emitting element.

1. A driving device for a light emitting display panel of a passive matrix type comprising a plurality of scanning lines and a plurality of data lines, which are intersecting one another, and self light emitting elements connected to each of the scanning lines and each of the data lines at intersecting positions of the scanning lines and data lines, wherein
the device comprises;
a switching means by which each of the scanning lines is set at a selection scanning voltage or a non-selection scanning voltage, at the side of a scanning driver, and
a switching means by which each of the data lines is connected to a lighting driving power source or a not-lighting driving power source at the side of a data driver, and
the not-lighting driving power source comprises a charging and discharging circuit.

2. A driving device for a light emitting display panel of a passive matrix type comprising a plurality of scanning lines and a plurality of data lines, which are intersecting one another, and self light emitting elements connected to each of the scanning lines and each of the data lines at intersecting positions of the scanning lines and data lines, wherein
the device comprises;
a switching means, by which each of the scanning line is set at a selection scanning voltage or a non-selection scanning voltage at the side of a scanning driver and switching means, by which each of the data lines is connected to any one of a lighting driving power source, a not-lighting driving power source, or a pre-charging voltage source at the side of a data driver,
the not-lighting driving power source and the pre-charging voltage source comprise at least one charging and discharging circuit.

3. The driving device for a light emitting display panel according to claim 2, wherein
the not-lighting driving power source and the pre-charging voltage source comprise a common charging and discharging circuit.

4. The driving device for a light emitting display panel according to claim 1, wherein
the charging and discharging circuit comprises a Zener diode and a capacitor which is connected to the Zener diode in parallel.

5. The driving device for a light emitting display panel according to claim 2, wherein
the charging and discharging circuit comprises a Zener diode and a capacitor which is connected to the Zener diode in parallel.

6. The driving device for a light emitting display panel according to claim 3, wherein
the charging and discharging circuit comprises a Zener diode and a capacitor which is connected to the Zener diode in parallel.

7. The driving device for a light emitting display panel according to claim 1 or 2, wherein the device has a configuration in which
a charging period in which the charging and discharging circuit is charged is set by connecting at least a part of the data lines to a not-lighting driving power source after scanning for lighting by which at least a part of the scanning lines are set at a selection scanning voltage, other parts of the scanning lines are set at a non-selection scanning voltage, and at least a part of the data lines are connected to a lighting driving power source.

8. The driving device for a light emitting display panel according to claim 7, wherein
the charging period is set every scanning of each scanning lines for lighting.

9. The driving device for a light emitting display panel according to claim 7, wherein
the charging period is set at scanning for lighting of a part of scanning lines which is selected in response to gradation data.

10. The driving device for a light emitting display panel according to claim 1 or 2, wherein the device has a configuration in which
a scanning period for not-lighting in which a reverse bias voltage is applied to at least a part of the self light emitting elements is set by setting at least a part of the scanning lines at the non-selection scanning potential, and by connecting at least a part of the data lines to the not-lighting driving power source.

11. The driving device for a light emitting display panel according to claim 7, wherein the device has a configuration in which
a scanning period for not-lighting in which a reverse bias voltage is applied to at least a part of the self light emitting elements is set by setting at least a part of the scanning lines at the non-selection scanning potential, and by connecting at least a part of the data lines to the not-lighting driving power source.

12. The driving device for a light emitting display panel according to claim 8, wherein the device has a configuration in which
a scanning period for not-lighting in which a reverse bias voltage is applied to at least a part of the self light emitting elements is set by setting at least a part of the scanning lines at the non-selection scanning potential, and by connecting at least a part of the data lines to the not-lighting driving power source.

13. The driving device for a light emitting display panel according to claim 9, wherein the device has a configuration in which
a scanning period for not-lighting in which a reverse bias voltage is applied to at least a part of the self light emitting elements is set by setting at least a part of the scanning lines at the non-selection scanning potential, and by connecting at least a part of the data lines to the not-lighting driving power source.

14. The driving device for a light emitting display panel according to claim 2, wherein the device has a configuration in which
a pre-charging period in which a parasitic capacitance of self light emitting elements is charged by setting at least a part of the scanning lines at the selection scanning voltage, by setting other parts of the scanning lines at the non-selection scanning voltage, and by connecting at least a part of the data lines to the pre-charging voltage source.

15. The driving device for a light emitting display panel according to claim 7, wherein the device has a configuration in which
a pre-charging period in which a parasitic capacitance of self light emitting elements is charged by setting at least a part of the scanning lines at the selection scanning voltage, by setting other parts of the scanning lines at the non-selection scanning voltage, and by connecting at least a part of the data lines to the pre-charging voltage source.

16. The driving device for a light emitting display panel according to any one of claims 4 through 6, wherein
a Zener voltage of the Zener diode is selected to be less than a light emitting threshold voltage of the self light-emitting element.

17. The driving device for a light emitting display panel according to any one of claims 4 through 6, wherein
the capacitance of the capacitor is configured to be set at a value larger than the sum of all the values of the parasitic capacitance of the light emitting elements arranged on the light emitting display panel.

18. The driving device for a light emitting display panel according to claim 1 or 2, wherein
the self light emitting elements arranged on the light emitting display panel are an organic EL element using an organic compound for a light emitting layer.

19. A driving method for a light emitting display panel of a passive driving type which comprises a plurality of scanning lines and a plurality of data lines, which are intersecting one another, and self light emitting elements connected to each of the scanning lines and each of the data lines at intersecting positions of the scanning lines and data lines, wherein the method includes the following steps to be executed:
a charging step in which a charging and discharging circuit is charged by setting each of the scanning lines at a selection scanning voltage one by one, by setting other scanning lines which have not been set at the selection scanning voltage at a non-selection scanning voltage, and by using charges accumulated in the parasitic capacitance of the light emitting elements which is corresponding to the scanning lines set at the non-selection scanning voltage; and
a step for applying a reverse bias voltage, in which a difference voltage between the non-selection scanning voltage and a voltage at which a charging and discharging circuit is charged is applied to the self light emitting elements as a reverse bias voltage by setting all the scanning lines at the non-selection scanning voltage.

20. A driving method for a light emitting display panel of a passive driving type which comprises a plurality of scanning lines and a plurality of data lines, which are intersecting one another, and self light emitting elements connected to each of the scanning lines and each of the data lines at intersecting positions of the scanning lines and data lines, wherein the method includes the following steps to be executed:
a charging step in which a charging and discharging circuit is charged by setting each of the scanning lines at a selection scanning voltage one by one, by setting other scanning lines which have not been set at the selection scanning voltage at a non-selection scanning voltage, and by using charges accumulated in the parasitic capacitance of the light emitting elements which is corresponding to the scanning lines set at the non-selection scanning voltage;
a step for applying a reverse bias voltage, in which a difference voltage between the non-selection scanning voltage and a voltage at which a charging and discharging circuit is charged is applied to the self light emitting elements as a reverse bias voltage by setting all the scanning lines at the non-selection scanning voltage; and
a pre-charging step in which the parasitic capacitance of the self light emitting elements is charged with voltage less than a light emitting threshold voltage at a forward direction by using a potential at which the charging and discharging circuit is charged.
